(19) United States
(12) Patent Application Publication
(10) Pub. No.: US 2005/0272922 A1
(43) Pub. Date: Dec. 8, 2005

(54) Processes for preparing crosslinker-free, biopolymer-containing three dimensional structures, and products prepared thereby

(76) Inventors: Andrea Heilemann, Illerkirchberg (DE); Josef Holzer, Illertissen (DE); Andreas Sander, Illertissen (DE); Gisbert Schaefer, Dietenheim (DE)

Correspondence Address: COGNIS CORPORATION;PATENT DEPARTMENT, 300 BROOKSIDE AVENUE, AMBLER, PA, 19002, US

(21) Appl. No.: 11/120,322

(22) Filed: May 2, 2005

Related U.S. Application Data
(63) Continuation of application No. 10/030,974, filed on May 13, 2002, now abandoned.

(30) Foreign Application Priority Data
Jul. 12, 1999 (DE) 199 32 075.6

(51) Int. Cl. C08B 37/08

(52) U.S. Cl. 536/20

(57) ABSTRACT

Processes for preparing crosslinker-free, chitosan-containing compositions, comprising: (a) providing an aqueous mixture of a chitosan, wherein the aqueous mixture has a viscosity of from 1,000 mPas to 100,000 mPas; (b) combining a precipitant with the aqueous mixture to form a crosslinker-free chitosan composition; and (c) drying the crosslinker-free chitosan composition to form a crosslinker-free three-dimensional structure; are described. Also described are three-dimensional structures prepared thereby and uses therefor in cosmetics, food additives and medical products

### CROSS-REFERENCE TO RELATED APPLICATIONS

This application is a continuation of co-pending application U.S. patent application Ser. No. 10/030,974, filed on May 13, 2002, which is a national stage application under 35 U.S.C. § 371 of International application number PCT/EP00/06162 filed Jul. 1, 2000 and claims priority from DE 199 32 075.6, filed Jul. 12, 1999, the entire contents of each application are incorporated herein by reference.

### BACKGROUND OF THE INVENTION

Beauty packs containing chitosan as their active component and organic acids and collagen as further constituents are known from Japanese patent application JP-A2 Hei 6/048 917 (Nagawa). Japanese patent application JP-A2 Hei 4/275 207 (Nitta Gelatin) relates to moisture-binding additives for skin cosmetics in the form of powder-form mixtures of chitosan and collagen. European patent application EP A2 627 225 (Hüls) describes superabsorbents of acid-reacted chitosans which are present in powder form.

German patent application DE-A1 196 43 066 (Henkel) describes collagen-free cosmetic preparations obtained by crosslinking cationic biopolymers with diisocyanates and/or dialdehydes. U.S. Pat. No. 5,322,935 (Allied Signal Inc.) relates to highly porous crosslinked materials of nitrogen-containing polymers and to a process for their production. In this process, a nitrogen-containing polymer is first dissolved in water or an aqueous acid, then ionically crosslinked with an anionic salt solution and, finally, is covalently crosslinked with crosslinking agents. Dialdehydes and aromatic and aliphatic diisocyanates are mentioned as examples of crosslinking agents. International patent application WO 96/20015 (Kimberly-Clark) describes water-swellable, water-insoluble chitosan salts with a defined absorption capacity under external pressure which can be prepared by crosslinking. Japanese patent application JP-A2 03165775 (Katakura Chikkarin Co.) describes the production of N-succinyl chitosans in the form of a multiporous sponge or film by crosslinking with hexamethylene diisocyanate. These sponges or films are suitable as a prosthetic material for wound dressings, artificial blood vessels or styptic dressings. European patent EP-B1 663 212 (Hydromer Inc.) describes gels obtained by crosslinking chitosans with polyvinyl pyrrolidone.

One feature common to all the known products is that the biopolymers are linked by chemical crosslinking of reactive centers of the biopolymers. In general, bifunctional reagents, such as dialdehydes or diisocyanates for example, are used for this purpose. Since the complete reaction of these chemical crosslinkers generally cannot be taken for granted, residues of the crosslinkers can remain in the product. This can cause irritations or allergic reactions, particularly in the case of preparations that remain on the skin for prolonged periods, such as cosmetics or healing aids, particularly masks, or wound dressings. This is a serious disadvantage, particularly in the case of wound dressings that are applied to already irritated or damaged skin. In addition, biodegradability is impaired by the addition of these chemical crosslinking agents.

In addition, products crosslinked with the usual chemical crosslinking agents cannot be used as foods or food supplements or as drug carriers for oral applications.

Accordingly, the problem addressed by the present invention was to provide crosslinker-free preparations which would have properties comparable with those of known preparations produced using crosslinking agents. In particular, it would be possible to produce a three-dimensional structure in the form of a block, nonwoven or mask. Particular attention would be directed in this regard to such properties as mechanical stability in both the dry and the wet state, swellability and compatibility with other possible ingredients. In addition, production would be simple and variable according to the required properties of the end product. The products would also be biodegradable.

### BRIEF SUMMARY OF THE INVENTION

The present invention relates, in general, to biopolymers and crosslinker-free preparations obtained by precipitation and subsequent drying of chitosans, and to a process for their production.

Thus, the present invention includes a crosslinker-free preparation obtainable by adding a precipitant to an aqueous solution and/or homogenized suspension of a chitosan and then drying.

### DETAILED DESCRIPTION OF THE INVENTION

It has surprisingly been found that the preparations obtainable in this way have properties comparable with those of known crosslinker-containing preparations. In particular, it is possible with the preparations according to the invention to produce three-dimensional structures, such as blocks, nonwovens or masks, which are comparable with the known products in regard to their mechanical stability, elasticity, swellability, water absorbtion capacity and compatibility with other ingredients. In addition, the preparations according to the invention show high dermatological compatibility and are biodegradable. They are also easy to produce on an industrial scale.

The mechanical stability of the preparations according to the invention, measured as tensile strength at break to DIN 53 571, test specimen B, is in the range from 10 to 1,000 mN/mm² and preferably in the range from 50 to 200 in the dry state and between 10 and 500 and preferably between 30 and 100 mN/mm² in the wet state. Their elasticity, measured as elongation at break in % to DIN 53 571, test specimen B, is between 1 and 50% and more particularly between 5 and 20% in the dry state.

The preparations according to the invention have a water absorption capacity of at least 5 g water/g product and, more particularly, of at least 15 g water/g product. To determine water absorption, the material is moistened with deionized water and weighed.

The present invention also relates to a process for the production of crosslinker-free preparations, characterized in that precipitants are added to aqueous solutions and/or homogenized suspensions of chitosans and the chitosans are then dried.

In contrast to chemical crosslinking, the process according to the invention is based on the observation that the addition of the precipitants results in a shift of the pH value which in turn results in partial or complete precipitation and, at the same time, in physical crosslinking of the biopolymer. In contrast to chemical crosslinking, the fibers are not crosslinked by covalent bonds, but presumably through the formation of ion pairs, electrostatic attraction and mechanical entanglement of the fibers.

Accordingly, “crosslinker-free” in the context of the present invention means that the mechanical stability of the preparation is attributable above all to physical crosslinking and, more particularly, that no chemical crosslinking agents, such as bifunctional or multifunctional reagents (for example dialdehydes or diisocyanates), are used for crosslinking.

Chitosans

Chitosans are biopolymers which belong to the group of hydrocolloids. Chemically, they are partly deacetylated chitins differing in their molecular weights which contain the following—idealized—monomer unit: 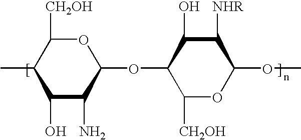
In contrast to most hydrocolloids, which are negatively charged at biological pH values, chitosans are cationic biopolymers under these conditions. The positively charged chitosans are capable of interacting with oppositely charged surfaces and are therefore used in cosmetic hair-care and body-care products and pharmaceutical preparations (cf. Ullmann's Encyclopedia of Industrial Chemistry, 5th Ed., Vol. A6, Weinheim, Verlag Chemie, 1986, pages 231-332). Overviews of this subject have also been published, for example, by B. Gesslein et al. in HAPPI 27, 57 (1990), O. Skaugrud in Drug Cosm. Ind. 148, 24 (1991) and E. Onsoyen et al. in Seifen-Öle-Fette-Wachse 117, 633 (1991). Chitosans are produced from chitin, preferably from the shell residues of crustaceans which are available in large quantities as inexpensive raw materials. In a process described for the first time by Hackmann et al., the chitin is normally first deproteinized by addition of bases, deminerlized by addition of mineral acids and, finally, deacetylated by addition of strong bases, the molecular weights being distributed over a broad spectrum. Corresponding processes are known, for example, from Makromol. Chem. 177, 3589 (1976) or French patent application FR 2701266 A. Preferred types are those which are disclosed in German patent applications DE 4442987 A1 and DE 19537001 A1 (Henkel) and which have an average molecular weight of 10,000 to 500,000,000 dalton, more particularly 10,000 to 500,000 dalton or 800,000 to 1,200,000 dalton and/or a Brookfield viscosity (1% by weight in glycolic acid) below 30,000 mPas, a degree of deacetylation of 80 to 88% and an ash content of less than 0.3% by weight. Besides chitosans as typical cationic biopolymers, derivatized chitosans where the cationic character is maintained by the derivatization are also suitable for use in accordance with the invention.
Aqueous Solutions and/or Homogenized Suspensions

The chitosans are used as aqueous solutions and/or homogenized suspensions. In general, the chitosans are dissolved or suspended in aqueous mineral acids or aqueous organic carboxylic acids. The suspensions of the chitosans generally contain dissolved fractions of chitosans. Suitable mineral acids are hydrochloric acid, phosphoric acid, nitric acid and sulfuric acid. Suitable organic carboxylic acids include formic acid, lactic acid, propionic acid, maleic acid, pyruvic acid, glycolic acid, succinic acid, acetic acid, citric aid, tartaric acid and adipic acid. Hydrochloric acid, lactic acid and glycolic acid are particularly preferred. The acid is used in the quantities required to partly or completely dissolve the chitosan. These are usually 10⁻⁴ to 10⁻² mol acid groups per g chitosan and more particularly 1-3×10⁻³ mol acid groups/g chitosan.

A 0.1 to 15% by weight aqueous solution or suspension is generally used, a 0.5 to 10% by weight and more particularly a 1.0 to 5.0% by weight aqueous solution or suspension being preferred and a 1.5 to 2.5% by weight aqueous solution or suspension being most particularly preferred. It has proved to be of advantage in this regard to adjust the concentration of the aqueous solution and/or suspension to such a value that the solution or suspension has a Brookfield viscosity of 1,000 to 100,000 mPas at 20° C. A viscosity of 10,000 to 40,000 mPas and preferably in the range from 15,000 to 35,000 mPas has proved to be particularly advantageous. In the case of a suspension which generally contains dissolved fractions, it can be of advantage to homogenize the suspension to obtain the required viscosity. In principle, any known methods of homogenization, for example using colloid mills or gap homogenizers, are suitable for this purpose. It has proved to be of particular advantage to use a colloid mill to prepare the homogenized suspensions. Homogenization is generally carried out at temperatures in the range from 0 to 100° C. and more particularly at temperatures of 30 to 65° C. The aqueous solution or homogenized suspension generally has a pH of 1.0 to 7.5 and more particularly in the range from 4.5 to 6.5.

Precipitants

In principle, any substances which increase the pH of the aqueous solution or homogenized suspension are suitable as precipitants for the purposes of the invention. Aqueous solutions of carbonates, hydrogen carbonates, hydrogen phosphates and hydroxides of the alkali and alkaline earth metals, ammonia and organic nitrogen bases may be used for this purpose. Suitable organic nitrogen bases are, for example, triethylamine, triethanolamine or tetraalkyl ammonium hydroxides. The aqueous solutions of the precipitants are normally used in a concentration of 5 to 20% by weight and more particularly 7 to 16% by weight. In one preferred embodiment of the present invention, an aqueous sodium hydrogen carbonate solution, more particularly a 7 to 16% by weight and preferably a 7 to 9% by weight aqueous sodium hydrogen carbonate solution, is used as the precipitant.

The present invention includes the observation that the mechanical properties of the end product can be influenced through the ratio of precipitant (base) to the quantity of acid present. If complete precipitation of the chitosan is required, the base is used in an equimolar quantity to the acid (generally 0.8-1.2 mol base:1 mol acid, more particularly 0.9-1.1 mol base:1 mol acid and most particularly 1 mol base:1 mol acid). If the requirements which the mechanical properties of the end product are expected to satisfy are less stringent, partial precipitation with less than the equimolar quantity of base can be carried out. Where high alkalinity is required in the end product, a molar excess of base may be used.

Through the treatment with the precipitant, the pH of the aqueous solution or homogenized suspension of the biopolymers is generally adjusted to a value of 5.0 to 14 and more particularly to a value of 7.0 to 8.5.

Drying

The present invention includes the observation that the mechanical stability of the end product can be influenced through the choice of the method used for drying and through the parameters of the particular method selected.

Suitable drying methods are, for example, air drying, vacuum drying, more particularly at temperatures of 20 to 100° C. or above 100° C., and freeze drying.

In one preferred embodiment of the present invention, freeze drying is used for drying.

It has proved to be particularly suitable for drying to be preceded by a freezing step. This is particularly advantageous in combination with freeze drying. The present invention includes the observation that the structure produced by precipitation of the fibers, which is fixed by the freezing step, remains substantially intact where drying is carried out by freeze drying. To this end, the suspension adjusted to the required viscosity and mixed with precipitants is frozen at temperatures below the freezing point taking the desired geometric form into consideration. The way in which the freezing step is carried out has a major bearing on the appearance and structure of the sponge formed after freeze drying. For example, the quicker the freezing step, the more finely porous and uniform the sponge formed after freeze drying will be. The freezing step may be carried out in standard freezing baths or even in refrigerators using liquefied gases, more particularly liquid nitrogen, as the refrigerating medium. Temporary storage of the frozen suspension for up to several days or weeks is possible in principle and does not adversely affect the quality of the end product.

Freeze drying is carried out by known methods as described, for example, by G. W. Oetjen in Gefriertrocknen, Wiley-VCH Verlag, 1997, 1st Edition, Weinheim. It has proved to be of advantage to carry out freeze drying in such a way that no part of the frozen material thaws either partly or completely at any time. From the economic perspective, it has proved to be of advantage to accelerate the drying process by applying energy, for example through radiant heat. To avoid discolorations, it is of advantage to increase temperatures in the already dried parts of the product at most to such a level that no product damage occurs.

Production of the Preparations

Normally, aqueous solutions or suspensions of the chitosans with a dry matter content of 0.1 to 15, preferably 0.5 to 10, more preferably 1.0 to 5.0% by weight and most preferably 1.5 to 2.5% by weight are prepared at a pH of 1.0 to 7.5 and preferably 4.5 to 6.5 by addition of inorganic or organic acids, preferably hydrochloric acid, glycolic acid and/or lactic acid, the temperature having to be selected so that it supports swelling of the chitosan. The temperature is normally in the range from 0 to 100° C. and preferably in the range from 30 to 65° C. Besides dissolved chitosan, the suspensions prepared in this way also contain swollen undissolved particles. The viscosity of the suspension adjusted through the conditions mentioned can influence the later mechanical properties of the nonwovens.

To improve elasticity in the dried state, polyols and other auxiliaries and additives may then be added to the suspensions. In addition, it has proved to be of advantage so far as the mechanical properties of the preparations are concerned to add natural fibers, for example lignin, polyose, pectin and in particular cellulose, or synthetic fibers, for example polyesters, polyamides, or mixtures thereof to the suspensions in a quantity of 1 to 50% by weight and preferably 5 to 10% by weight. It is particularly advisable to add the fibers to the solution or suspension before homogenization. The suspensions are then homogenized. After their preparation in the desired viscosity range, the aqueous solutions and/or homogenized suspensions are generally degassed, for example by vacuum or ultrasound, to avoid the entrapment of gas bubbles.

The addition and homogeneous distribution of the precipitant can be carried out so quickly (generally 1 to 10 and preferably 1 to 4 minutes) that the precipitation and physical crosslinking of the chitosan mainly takes place after the corresponding freezing mold has been filled. It has proved to be of particular advantage so far as the development of physical crosslinking is concerned to allow the product to stand for 10 mins. to 10 hours and more particularly for 30 mins. to 6 hours without any further mixing. The precipitant may be added through a mixing element with static and/or moving internals. The resulting suspension can be introduced into a suitable mold corresponding to the geometric shape required for the end product. Depending on the shape required for the end product, the mold may be a bowl, tube, hose, syringe, etc. Different layer thicknesses of the end product can be adjusted in freezing bowls through the filling level of the suspension. Layer thicknesses of 1 to 100 mm and more particularly 15 to 35 mm can be adjusted for the production of preparations in the form of nonwovens which are used, for example, as cosmetic products or healing aids or medicinal products.

A freezing phase is then normally carried out before the preparation is dried.

The addition of other auxiliaries and additives may be carried out both before and together with the addition of the precipitant. The other auxiliaries and additives are preferably added before the precipitant. In this case, too, it is of advantage to adjust the solutions or suspensions containing the other auxiliaries and additives to a viscosity of 1,000 to 100,000, preferably to a viscosity of 10,000 to 40,000 and more preferably to a viscosity of 15,000 to 35,000 mPas before the precipitant is added.

In another embodiment of the invention, the crosslinker-free preparations are charged with auxiliaries and additives after drying. In this case, cosmetic and pharmaceutical active components or flavors, for example, are applied by special techniques to the final dry preparation after freeze drying. To this end, the active component is dissolved in a suitable solvent, applied to the sponge formed after freeze drying, which in this embodiment, acts as a carrier material and the solvent is then carefully removed. Suitable solvents are, for example, supercritical CO₂ or nonpolar or polar organic solvents such as, for example, hexane, ethanol or isopropanol.

The present invention includes the observation that, in a crosslinker-free preparation, auxiliaries and additives may be added both before or together with the precipitant and also after drying.

Auxiliaries and Additives

The auxiliaries and additives used may be substances which are compatible with the crosslinker-free preparations and which positively influence the physical properties of the preparations and/or impart additional functions to the preparations. Particularly preferred auxiliaries and additives are substances selected from the group consisting of polyols, emulsifiers, fibers, dyes, perfume oils, flavors, cosmetic active components, pharmaceutical active principles and food additives.

The preparations according to the invention may contain small quantities of oil components, synthetic and natural hydrocarbons, waxes, cationic polymers, thickeners, silicone compounds, biogenic agents, film formers, preservatives, solubilizers, structure formers and protective solutions (cryoprotectant agents ═CPA), UV protection factors and the like as further auxiliaries and additives.

Polyols suitable for use in accordance with the invention as additional constituents of the crosslinker-free preparations preferably contain 2 to 15 carbon atoms and at least two hydroxyl groups. Typical examples are
glycerol;
alkylene glycols such as, for example, ethylene glycol, diethylene glycol, propylene glycol, butylene glycol, hexylene glycol and polyethylene glycols with an average molecular weight of 100 to 1,000 dalton;
technical oligoglycerol mixtures with a degree of self-condensation of 1.5 to 10 such as, for example, technical diglycerol mixtures with a diglycerol content of 40 to 50% by weight;
lower alkyl glucosides, particularly those containing 1 to 8 carbon atoms in the alkyl group, for example methyl and butyl glucoside;
sugar alcohols containing 5 to 12 carbon atoms, for example sorbitol or mannitol,
sugars containing 5 to 12 carbon atoms, for example glucose or sucrose;
aminosugars, for example glucamine.

The polyols are normally used in quantities of 0.1 to 20% by weight and preferably in quantities of 1 to 10% by weight, based on the dry matter content of the chitosan. Glycerol and polyethylene glycols are preferably used as the polyols.

Suitable emulsifiers are, for example, nonionic surfactants from at least one of the following groups:
(b1) products of the addition of 2 to 30 moles ethylene oxide and/or 0 to 5 moles propylene oxide onto linear fatty alcohols containing 8 to 22 carbon atoms, onto fatty acids containing 12 to 22 carbon atoms and onto alkylphenols containing 8 to 15 carbon atoms in the alkyl group;
(b2) C_{12/18} fatty acid monoesters and diesters of adducts of 1 to 30 moles of ethylene oxide with glycerol;
(b3) glycerol monoesters and diesters and sorbitan monoesters and diesters of saturated and unsaturated fatty acids containing 6 to 22 carbon atoms and ethylene oxide adducts thereof;
(b4) alkyl mono- and oligoglycosides containing 8 to 22 carbon atoms in the alkyl group and ethoxylated analogs thereof;
(b5) products of the addition of of 15 to 60 moles ethylene oxide onto castor oil and/or hydrogenated castor oil;
(b6) polyol esters and, in particular, polyglycerol esters such as, for example, polyglycerol polyricinoleate or polyglycerol poly-12-hydroxystearate. Mixtures of compounds from several of these classes are also suitable;
(b7) products of the addition of 2 to 15 moles ethylene oxide with castor oil and/or hydrogenated castor oil;
(b8) partial esters based on linear, branched, unsaturated or saturated C_{12/22} fatty acids, ricinoleic acid and 12-hydroxystearic acid and glycerol, polyglycerol, pentaerythritol, dipentaerythritol, sugar alcohols (for example sorbitol) and polyglucosides (for example cellulose);
(b9) trialkyl phosphates;
(b10) wool wax alcohols;
(b11) polysiloxane/polyalkyl polyether copolymers and corresponding derivatives;
(b12) mixed esters of pentaerythritol, fatty acids, citric acid and fatty alcohol according to DE-PS 11 65 574 and/or mixed esters of fatty acids containing 6 to 22 carbon atoms, methyl glucose and polyols, preferably glycerol, and
(b13) polyalkylene glycols.

The addition products of ethylene oxide and/or propylene oxide onto fatty alcohols, fatty acids, alkylphenols, glycerol monoesters and diesters and sorbitan monoesters and diesters of fatty acids or onto castor oil are known commercially available products. They are homolog mixtures of which the average degree of alkoxylation corresponds to the ratio between the quantities of ethylene oxide and/or propylene oxide and substrate with which the addition reaction is carried out. C_{12/18} fatty acid monoesters and diesters of addition products of ethylene oxide onto glycerol are known as refatting agents for cosmetic formulations from DE-PS 20 24 051.

C_{8/18} alkyl mono- and oligoglycosides, their production and their use as surfactants are known, for example, from U.S. Pat. No. 3,839,318, U.S. Pat. No. 3,707,535, U.S. Pat. No. 3,547,828, DE-OS 19 43 689, DE-OS 20 36 472 and DE-A1 30 01 064 and also from EP-A 0 077 167. They are produced in particular by reacting glucose or oligosaccharides with primary C₈₋₁₈ alcohols. So far as the glycoside unit is concerned, both monoglycosides in which a cyclic sugar unit is attached to the fatty alcohol by a glycoside bond and oligomeric glycosides with a degree of oligomerization of preferably up to about 8 are suitable. The degree of oligomerization is a statistical mean value on which the homolog distribution typical of such technical products is based.

The emulsifiers are normally used in quantities of 0.1 to 20% by weight and preferably in quantities of 1 to 10% by weight, based on the dry matter content of the chitosan.

Suitable oil components are, for example, Guerbet alcohols based on C₆₋₁₈ and preferably C₈₋₁₀ fatty alcohols, esters of linear C₆₋₂₀ fatty acids with linear C₆₋₂₀ fatty alcohols, esters of branched C₆₋₁₃ carboxylic acids with linear C₆₋₂₀ fatty alcohols, esters of linear C₆₋₁₈ fatty acids with branched alcohols, more particularly 2-ethyl hexanol, esters of linear and/or branched fatty acids with polyhydric alcohols (for example dimer diol or trimer triol) and/or Guerbet alcohols, triglycerides based on C₆₋₁₀ fatty acids, esters of C₆₋₂₂ fatty alcohols and/or Guerbet alcohols with aromatic carboxylic acids, more particularly benzoic acid, vegetable oils, branched primary alcohols, substituted cyclohexanes, Guerbet carbonates, dialkyl ethers, silicone oils and/or aliphatic or naphthenic hydrocarbons.

Examples of synthetic hydrocarbons which may be used in accordance with the invention are hydrogenated polyisobutene (synthetic squalane), polyisobutene, polyethylene, polypropylene. Suitable natural hydrocarbons are terpenes, for example squalene or squalane. The hydrocarbons are normally used in quantities of 0.1 to 20% by weight and preferably in quantities of 1 to 10% by weight, based on the dry matter content of the chitosans.

Suitable thickeners are, for example, polysaccharides, more especially xanthan gum, guar-guar, agar-agar, alginates and tyloses, carboxymethyl cellulose and hydroxyethyl cellulose, also relatively high molecular weight polyethylene glycol monoesters and diesters of fatty acids, polyacrylates, polyvinyl alcohol and polyvinyl pyrrolidone.

Suitable cationic polymers are, for example, cationic cellulose derivatives, cationic starch, copolymers of diallyl ammonium salts and acrylamides, quaternized vinyl pyrrolidone/vinyl imidazole polymers such as, for example, Luviquat® (BASF AG, Ludwigshafen, FRG), condensation products of polyglycols and amines, quaternized collagen polypeptides such as, for example, Lauryldimonium Hydroxypropyl Hydrolyzed Collagen (Lamequat® L, Grunau GmbH), quaternized wheat polypeptides, polyethyleneimine, cationic silicone polymers such as, for example, amodimethicone or Dow Corning, Dow Corning Co., USA, copolymers of adipic acid and dimethylaminohydroxypropyl diethylenetriamine (Cartaretine®, Sandoz AG, CH), polyaminopolyamides as described, for example, in FR-A 2 252 840 and crosslinked water-soluble polymers thereof, cationic chitin derivatives such as, for example, quaternized chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar® CBS, Jaguar® C-17, Jaguar® C-16 of Celanese, USA, quaternized ammonium salt polymers such as, for example, Mirapol® A-15, Mirapol® AD-1, Mirapol® AZ-1 of Miranol, USA.

Suitable silicone compounds are, for example, dimethyl polysiloxanes, methylphenyl polysiloxanes, cyclic silicones and amino-, fatty acid-, alcohol-, polyether-, epoxy-, fluorine- and/or alkyl-modified silicone compounds which may be both liquid and resin-like at room temperature.

In the context of the invention, biogenic agents are, for example, bisabolol, allantoin, phytantriol, panthenol, AHA acids, plant extracts, marine extracts, vitamins and vitamin complexes.

Film formers are, for example, chitosan, microcrystalline chitosan, quaternized chitosan, polyvinyl pyrrolidone, vinyl pyrrolidone/vinyl acetate copolymers, polymers of the acrylic acid series, quaternary cellulose derivatives, collagen, hyaluronic acid and salts thereof and similar compounds.

The dyes used may be selected from any of the substances which are approved and suitable for cosmetic purposes, as listed for example in the publication “Kosmetische Färbemittel” of the Farbstoffkommission der Deutschen Forschungsgemeinschaft, published by Verlag Chemie, Weinheim, 1984, pages 81-106. These dyes are typically used in concentrations of 0.001 to 0.1% by weight, based on the mixture as a whole.

The fibers used may be both natural fibers and synthetic fibers and mixtures thereof. Suitable natural fibers are, for example, lignin, polyose, pectin and, in particular, cellulose. Suitable synthetic fibers are, for example, polyesters, polyamides or mixtures thereof. The fibers are preferably used in a quantity of 1 to 50% by weight and preferably in a quantity of 5 to 10% by weight.

Waxes are natural or synthetic substances which are are kneadable at 20° C., solid to fragile and hard, coarsely to finely crystalline, transparent to opaque, but not glass-like, melt without decomposing above 40° C. and are of comparatively low viscosity and non-stringing even just above their melting point. The waxes suitable for use in accordance with the invention differ from resins, for example, in the fact that they change into a molten low-viscosity state at temperatures of generally about 50 to 90° C., in exceptional cases even as high as 200° C., and are substantially free from ash-forming compounds. The waxes are divided into the following three groups according to their origin: natural waxes such as, for example, candelilla wax, carnauba wax, Japan wax, espartograss wax, cork wax, guaruma wax, rice oil wax, sugar cane wax, ouricury wax, montan wax, beeswax, shellac wax, spermaceti, lanolin (wool wax), uropygial fat, ceresine, ozocerite (earth wax), petrolatum, paraffin waxes and microwaxes; chemically modified waxes (hard waxes) such as, for example, montan ester waxes, sasol waxes, hydrogenated jojoba waxes and synthetic waxes such as, for example, polyalkylene waxes and polyethylene glycol waxes. In this connection, natural waxes, especially vegetable waxes, are preferred.

Flavors are concentrated preparations of aromas or flavoring agents which are intended to give foods a particular aroma or taste. Examples are vanillin, peppermint oil, Maillard products, banana flavoring and many others. Important aroma carriers are the essential oils and mixtures of individual, generally synthetically produced, so-called “nature-identical” components of these oils. At present, there are about 600 natural and about 4,200 nature-identical aromas for foods, cosmetic products and pharmaceutical products. Suitable perfume oils are, for example, mixtures of natural and synthetic perfumes. Natural perfumes include the extracts of blossoms, stems and leaves, fruits, fruit peel, roots, woods, herbs and grasses, needles and branches, resins and balsams. Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, p-tert.butyl cyclohexylacetate, linalyl acetate, phenyl ethyl acetate, linalyl benzoate, benzyl formate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable fragrance. Other suitable perfume oils are essential oils of relatively low volatility which are mostly used as aroma components. Examples are sage oil, camomile oil, clove oil, melissa oil, mint oil, cinnamon leaf oil, lime-blossom oil, juniper berry oil, vetiver oil, olibanum oil, galbanum oil, labolanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, romilat, irotyl and floramat.

The food additives used are substances without or with nutritional value which generally are neither consumed as foods themselves or used as characteristic food additives or added to a food for technological reasons during production, processing, preparation, treatment, packaging, handling or storage so that they themselves or their secondary products become or could become parts of the food. Some food additives are of natural origin such as, for example, carotene from carrots, chlorophyll from green plants, lecithin from eggs or soya beans. Others, by contrast, are purely synthetic chemicals such as, for example, the azo dyes tartrazine and amaranth, the antioxidants BHA and BHT and the sweeteners saccharin and cyclamate.

Pharmaceutical active principles in the context of the invention are active components and healing aids and their vehicles made up in various medicinal forms. Azelaic acid as an antiacne agent and PVP/iodine complex as a disinfectant are mentioned by way of example.

Suitable cosmetic active components are any substances which are suitable for use in cosmetic preparations.

Suitable preservatives are, for example, phenoxyethanol, formaldehyde solution, parabens, pentanediol or sorbic acid and the other classes of compounds listed in Appendix 6, Parts A and B of the Kosmetikverordnung (ACosmetics Directive≅).

Examples of UV protection factors are organic substances (light filters) which are liquid or crystalline at room temperature and which are capable of absorbing ultraviolet radiation and of releasing the energy absorbed in the form of longer-wave radiation, for example heat. UV-B filters can be oil-soluble or water-soluble. The following are examples of oil-soluble substances:
3-benzylidene camphor or 3-benzylidene norcamphor and derivatives thereof, for example 3-(4-methylbenzylidene)-camphor, as described in EP 0693471 B1;
4-aminobenzoic acid derivatives, preferably 4-(dimethylamino)-benzoic acid-2-ethylhexyl ester, 4-(dimethylamino)-benzoic acid-2-octyl ester and 4-(dimethylamino)-benzoic acid amyl ester;
esters of cinnamic acid, preferably 4-methoxycinnamic acid-2-ethylhexyl ester, 4-methoxycinnamic acid propyl ester, 4-methoxycinnamic acid isoamyl ester, 2-cyano-3,3-phenylcinnamic acid-2-ethylhexyl ester (Octocrylene);
esters of salicylic acid, preferably salicylic acid-2-ethylhexyl ester, salicylic acid-4-isopropylbenzyl ester, salicylic acid homomenthyl ester;
derivatives of benzophenone, preferably 2-hydroxy-4-methoxybenzophenone, 2-hydroxy-4-methoxy-4′-methylbenzophenone, 2,2′-dihydroxy-4-methoxybenzophenone;
esters of benzalmalonic acid, preferably 4-methoxybenzalmalonic acid di-2-ethylhexyl ester;
triazine derivatives such as, for example, 2,4,6-trianilino-(p-carbo-2′-ethyl-1′-hexyloxy)-1,3,5-triazine and Octyl Triazone, as described in EP 0 818 450 A1, or Dioctyl Butamido Triazine (Uvasorb® HEB);
propane-1,3-diones such as, for example, 1-(4-tert.butylphenyl)-3-(4′-methoxyphenyl)-propane-1,3-dione;
ketotricyclo(5.2.1)decane derivatives, as described in EP 0 694 521 B1.

Suitable water-soluble substances are
2-phenylbenzimidazole-5-sulfonic acid and alkali metal, alkaline earth metal, ammonium, alkylammonium, alkanolammonium and glucammonium salts thereof;
sulfonic acid derivatives of benzophenones, preferably 2-hydroxy-4-methoxybenzophenone-5-sulfonic acid and salts thereof;
sulfonic acid derivatives of 3-benzylidene camphor such as, for example, 4-(2-oxo-3-bornylidenemethyl)-benzene sulfonic acid and 2-methyl-5-(2-oxo-3-bornylidene)-sulfonic acid and salts thereof.

Typical UV-A filters are, in particular, derivatives of benzoyl methane such as, for example 1-(4′-tert.butylphenyl)-3-(4′-methoxyphenyl)-propane-1,3-dione, 4-tert-butyl-4′-methoxydibenzoylmethane (Parsol 1789), 1-phenyl-3-(4′-isopropylphenyl)-propane-1,3-dione and the eneamine compounds described in DE 19712033 A1 (BASF). The UV-A and UV-B filters may of course also be used in the form of mixtures. Besides the soluble substances mentioned, insoluble pigments, i.e. finely dispersed metal oxides or salts, may also be used for this purpose. Examples of suitable metal oxides are, in particular, zinc oxide and titanium dioxide and also oxides of iron, zirconium, silicon, manganese, aluminium and cerium and mixtures thereof. Silicates (talcum), barium sulfate and zinc stearate may be used as salts. The oxides and salts are used in the form of the pigments for skin-care and skin-protecting emulsions and decorative cosmetics. The particles should have an average diameter of less than 100 nm, preferably from 5 to 50 nm and more preferably from 15 to 30 nm. They may be spherical in shape although ellipsoidal particles or other non-spherical particles may also be used. The pigments may also be surface-treated, i.e. hydrophilicized or hydrophobicized. Typical examples are coated titanium dioxides such as, for example, Titandioxid T 805 (Degussa) or Eusolex® T2000 (Merck). Suitable hydrophobic coating materials are, above all, silicones and particularly trialkoxyoctyl silanes or simethicones. So-called micro- or nanopigments are preferably used in sun protection products. Micronized zinc oxide is preferably used. Other suitable UV filters can be found in P. Finkel=s review in SÖFW-Journal 122, 543 (1996).

Besides the two above-mentioned groups of primary protection factors, secondary protection factors of the antioxidant type may also be used. Secondary sun protection factors of the antioxidant type interrupt the photochemical reaction chain which is initiated when UV rays penetrate into the skin. Typical examples of suitable antioxidants are amino acids (for example glycine, histidine, tyrosine, tryptophane) and derivatives thereof, imidazoles (for example urocanic acid) and derivatives thereof, peptides, such as D,L-carnosine, D-carnosine, L-carnosine and derivatives thereof (for example anserine), carotinoids, carotenes (for example α-carotene, β-carotene, lycopene) and derivatives thereof, chlorogenic acid and derivatives thereof, liponic acid and derivatives thereof (for example dihydroliponic acid), aurothioglucose, propylthiouracil and other thiols (for example thioredoxine, glutathione, cysteine, cystine, cystamine and glycosyl, N-acetyl, methyl, ethyl, propyl, amyl, butyl and lauryl, palmitoyl, oleyl, γ-linoleyl, cholesteryl and glyceryl esters thereof) and their salts, dilaurylthiodipropionate, distearylthiodipropionate, thiodipropionic acid and derivatives thereof (esters, ethers, peptides, lipids, nucleotides, nucleosides and salts) and sulfoximine compounds (for example butionine sulfoximines, homocysteine sulfoximine, butionine sulfones, penta-, hexa- and hepta-thionine sulfoximine) in very small compatible dosages (for example pmole to μmole/kg), also (metal) chelators (for example α-hydroxyfatty acids, palmitic acid, phytic acid, lactoferrine), α-hydroxy acids (for example citric acid, lactic acid, malic acid), humic acid, bile acid, bile extracts, bilirubin, biliverdin, EDTA, EGTA and derivatives thereof, unsaturated fatty acids and derivatives thereof (for example γ-linolenic acid, linoleic acid, oleic acid), folic acid and derivatives thereof, ubiquinone and ubiquinol and derivatives thereof, vitamin C and derivatives thereof (for example ascorbyl palmitate, Mg ascorbyl phosphate, ascorbyl acetate), liponic acid, tocopherols and derivatives (for example vitamin E acetate), vitamin A and derivatives (vitamin A palmitate) and coniferyl benzoate of benzoin resin, rutinic acid and derivatives thereof, α-glycosyl rutin, ferulic acid, furfurylidene glucitol, carnosine, butyl hydroxytoluene, butyl hydroxyanisole, nordihydroguaiac resin acid, nordihydroguaiaretic acid, trihydroxybutyrophenone, uric acid and derivatives thereof, mannose and derivatives thereof, Superoxid-Dismutase, zinc and derivatives thereof (for example ZnO, ZnSO₄), selenium and derivatives thereof (for example selenium methionine), stilbenes and derivatives thereof (for example stilbene oxide, trans-stilbene oxide) and derivatives of these active principles suitable for the purposes of the invention (salts, esters, ethers, sugars, nucleotides, nucleosides, peptides and lipids).

Cryoprotectant agents are, for example, sugar solutions, such as sucrose, maltose or the like, glycerol, PVP or even buffer solutions.

The total percentage content of auxiliaries and additives can be from 0.1 to 50% by weight and is preferably from 0.5 to 10% by weight, based on the dry matter of the chitosan.

Commercial Applications

The preparations according to the invention are distinguished by high dermatological compatibility and a high absorption capacity for liquids. Accordingly, the present invention also relates to the use of the preparations according to the invention as cosmetic preparations, more particularly as dry films, absorbers and cosmetic masks and styptic sponges for small cuts, for example caused by shaving.

The present invention also relates to the use of the preparations according to the invention as healing aids and/or medicinal products, more particularly as wound tampons, wound dressings, burn dressings, bandages releasing active principles, nonwovens and as drug carriers for oral applications. In this embodiment, the preparations according to the invention may be charged with various topical pharmaceutical formulations. For oral applications, the preparations according to the invention may be used, for example, as carriers, for example for antibiotics, analgesics and the like.

The present invention also relates to the use of the preparations according to the invention as foods. Foods in the context of this embodiment are any substances which are intended for human consumption in unmodified, prepared or processed form. Foods under this definition also include in particular food supplements and dietetic foods. In addition, the preparations according to the invention are suitable for use as food additives.

### EXAMPLES

### Example 1

A suspension of 2 kg chitosan (Hydagen® CMFP, Henkel KGaA), 98 kg water and 0.346 kg L-(+) lactic acid was homogenized in a colloid mill at a temperature of 40° C. until a viscosity of 23,000 mPas was reached. The suspension was then cooled to 10° C. and degassed in vacuo. 9 kg of the suspension were mixed for 2 minutes with 360 g of an aqueous solution of sodium hydrogen carbonate (=8.05% by weight aqueous sodium hydrogen carbonate solution) and then poured into molds. The layer thickness of the suspension in the mold was 22 mm. After standing for 3 h, the suspension was frozen and the frozen plates were freeze-dried at 80° C./1 mbar.

The dried blocks were then cut to the required size and thickness (thickness: 1.2 mm, size: 20×30 cm).

### Example 2

A suspension of 2 kg chitosan, 98 kg water, 0.292 kg glycolic acid, 0.1 kg cellulose fibers and 0.08 kg emulsifier PEG-30 Glyceryl Stearate (Tagat S®, Tego Cosmetics, Goldschmidt) was homogenized in a colloid mill at a temperature of 50° C. until a viscosity of 26,000 mPas was reached. The suspension was then cooled to 10° C. and degassed in vacuo. 9 kg of the suspension were mixed for 1 minute with 360 g of an aqueous solution of sodium hydrogen carbonate (=8.05% by weight aqueous sodium hydrogen carbonate solution) and then poured into molds. After standing for 30 mins., the suspension was frozen and the frozen plates were freeze-dried at 80° C./1 mbar.

The dried blocks were then cut to the required size and thickness (thickness: 1.5 mm, size: 20×30 cm).

### Example 3

A suspension of 2 kg chitosan, 98 kg water, 0.7 kg hydrochloric acid (20% by weight), 0.1 kg cellulose fibers, 0.1 kg glycerol and 0.08 kg emulsifier PEG-30 Glyceryl Stearate (Tagat S®, Tego Cosmetics, Goldschmidt) was homogenized in a colloid mill at a temperature of 60° C. until a viscosity of 30,000 mPas was reached. The suspension was then cooled to 10° C. and degassed in vacuo. 9 kg of the suspension were mixed for 4 minutes with 360 g of a saturated aqueous solution of sodium hydrogen carbonate and then poured into molds. After standing for 6 h, the suspension was frozen and then freeze-dried at 80° C./1 mbar.

The dried blocks were then cut to the required size and thickness (thickness: 5 mm, size: 5×8 cm).

Viscosity Measurement

All the viscosities shown were measured with a Brookfield DV1 viscosimeter (spindle 4, speed 12 r.p.m., 20° C.).

Mechanical Stability, Water Absorption Capacity and Wetting Time

The mechanical stability of the products obtained in accordance with Examples 1 to 3, measured as tensile strength at break to DIN 53 571, test specimen B, was between 100 and 150 mN/mm² in the dry state and between 50 and 70 mN/mm² in the wet state. Their elasticity, measured as elongation at break in %, was between 8 and 10% in the dry state.

The preparations according to the invention have a water absorption capacity of ca. 20 g water/g product. To determine water absorption, the material is moistened with deionized water and weighed.

The preparations according to the invention have a wetting time of ca. 1-2 mins. Wettability is determined by the following method: a 26 mm wide and 1.2 mm thick strip of the sample to be measured is taken, immersed at one end in a water-filled tray and then stretched onto a horizontal bench. The wetting time shown is the time which the horizontal strip takes to be completely wetted by the capillary forces of the sample alone over a distance of 30 mm.

1. A process for preparing a crosslinker-free composition, said process comprising:
(a) providing an aqueous mixture of a chitosan, wherein the aqueous mixture has a viscosity of from 1,000 mPas to 100,000 mPas;
(b) combining a precipitant with the aqueous mixture in an amount and at a rate sufficient to precipitate the chitosan such that a crosslinker-free chitosan composition having physically entangled strands of the chitosan is formed; and
(c) drying the crosslinker-free chitosan composition to form a crosslinker-free three-dimensional structure.

2. The process according to claim 1, wherein the aqueous mixture is present in a state selected from the group consisting of solutions and homogenous suspensions.

3. The process according to claim 1, wherein the chitosan is present in an amount of from 0.1 to 15% by weight, based on the aqueous mixture.

4. The process according to claim 1, wherein the aqueous mixture has a pH value of from 1 to 7.5.

5. The process according to claim 1, wherein the aqueous mixture has a viscosity of from 10,000 mPas to 40,000 mPas.

6. The process according to claim 1, wherein the chitosan comprises a cationically-derivatized chitosan.

7. The process according to claim 1, wherein the precipitant comprises an aqueous solution selected from the group consisting of aqueous solutions of hydrogen carbonates, carbonates, hydrogen phosphates, hydroxides of alkali metals, alkaline earth metals, ammonia and organic nitrogen bases, and combinations thereof.

8. The process according to claim 1, wherein the precipitant comprises an aqueous solution of sodium hydrogen carbonate.

9. The process according to claim 1, wherein the crosslinker-free chitosan composition formed in step (b) has a pH value of from 5 to 14.

10. The process according to claim 1, wherein the drying of the crosslinker-free chitosan composition comprises freeze-drying.

11. The process according to claim 1, further comprising combining one or more auxiliaries or additives with the aqueous mixture prior to drying.

12. The process according to claim 1, further comprising combining one or more auxiliaries or additives with the crosslinker-free composition subsequent to drying.

13. A process for preparing a crosslinker-free composition, said process comprising:
(a) providing an aqueous mixture of a cationically-derivatized chitosan, wherein the aqueous mixture has a viscosity of from 10,000 mPas to 40,000 mPas and a pH value of from 1 to 7.5;
(b) combining a precipitant selected from the group consisting of aqueous solutions of hydrogen carbonates, carbonates, hydrogen phosphates, hydroxides of alkali metals, alkaline earth metals, ammonia and organic nitrogen bases, and combinations thereof, with the aqueous mixture in an amount and at a rate sufficient to precipitate the chitosan such that a crosslinker-free chitosan composition having physically entangled strands of the chitosan is formed; and
(c) freeze-drying the crosslinker-free chitosan composition to form a crosslinker-free three-dimensional structure.

14. A crosslinker-free, chitosan composition prepared by the process according to claim 1.

15. A crosslinker-free, chitosan composition prepared by the process according to claim 5.

16. A crosslinker-free, chitosan composition prepared by the process according to claim 7.

17. A crosslinker-free, chitosan composition prepared by the process according to claim 10.

18. A crosslinker-free, chitosan composition prepared by the process according to claim 13.

19. A cosmetic preparation comprising a crosslinker-free, chitosan composition prepared by the process according to claim 1.

20. A food additive comprising a crosslinker-free, chitosan composition prepared by the process according to claim 1.

21. A process for preparing a crosslinker-free composition, said process comprising:
(a) providing an aqueous mixture of a chitosan, wherein the aqueous mixture has a viscosity of from 1,000 mPas to 100,000 mPas;
(b) combining a precipitant with the aqueous mixture in an amount and at a rate sufficient to precipitate the chitosan such that a crosslinker-free chitosan composition having physically entangled strands of the chitosan is formed;
(c) allowing the crosslinker-free chitosan composition to stand, without mixing, for 10 minutes to 10 hours; and
(d) drying the crosslinker-free chitosan composition to form a crosslinker-free three-dimensional chitosan structure.

22. A process for preparing a crosslinker-free chitosan composition, said process comprising:
(a) providing an aqueous mixture of a chitosan, wherein the aqueous mixture has a viscosity of from 1,000 mPas to 100,000 mPas;
(b) precipitating a crosslinker-free chitosan composition having physically entangled strands of the chitosan by adding a precipitant to the aqueous mixture in an amount and at a rate sufficient to precipitate said crosslinker-free composition; and
(c) forming a crosslinker-free three-dimensional structure by drying the resulting crosslinker-free chitosan composition.
